(19) United States
(12) Patent Application Publication
(10) Pub. No.: US 2022/0053248 A1
(43) Pub. Date: Feb. 17, 2022

(54) COLLABORATIVE EVENT-BASED MULTIMEDIA SYSTEM AND METHOD

(71) Applicant: Motorsport Network, Miami, FL (US)

(72) Inventor: Eric Gilbert, Miami Beach, FL (US)

(21) Appl. No.: 17/402,074

(22) Filed: Aug. 13, 2021

Related U.S. Application Data
(60) Provisional application No. 63/064,953, filed on Aug. 13, 2020.

(51) Int. Cl. H04N 21/8547; H04N 21/258

(52) U.S. Cl. CPC H04N 21/8547; H04N 21/25841; H04N 21/25866

(57) ABSTRACT

A multimedia collaboration system including a collaboration server configured to ingest a first media production being produced for an event, to detect a user location of a user with respect to an event location of the event, to register the user as a local event spectator or a remote event spectator based on determining the user location relative to the event location, to receive contributor multimedia content from at least one contributor user registered as one of the event spectator or the remote event spectator and synchronize the received contributor multimedia content with the first media production of the event, and to transmit a composite multimedia output comprising the synchronized received contributor multimedia content from the at least one contributor user, to receive a user selection of at least one synchronized multimedia content of the composite multimedia output, and to transmit to a user device the at least one user selected synchronized multimedia content based on receiving the user selection from the user device.

### CROSS-REFERENCE TO RELATED APPLICATIONS

This application claims the benefit of U.S. Provisional Patent Application Ser. No. 63/064,953 filed Aug. 13, 2020. The disclosure of the application listed above is incorporated herein by reference in its entirety.

### BACKGROUND

Sporting and performance spectator events attended by crowds of spectators may have an officially produced live broadcast media feed that may be telecast live often around the world while the event may be taking place. Given the promulgation of wireless mobile communication devices connected to communication service provider networks wherein the mobile devices include hardware enabling users to take and upload to the communication network digital images, video and associated user-input comments, there exists a need to supplement the event official produced media feed with user-provided point-of-view (POV) media to produce a collaborative media feed of POV media synchronized to the official produced media fee. This synchronized collaborative media fee may enable other users either at or remote from the spectator event to select and view additional multimedia content either in conjunction with or independently from the official media feed.

### SUMMARY

It should be appreciated that this Summary is provided to introduce a selection of concepts in a simplified form that are further described below in the Detailed Description. This Summary is not intended to be used to limit the scope of the claimed subject matter.

In one configuration disclosed herein, a multimedia collaboration system includes a collaboration server including a collaboration server processor coupled to a collaboration server memory configured to store collaboration server processor instructions that when executed by the collaboration server processor are configured to ingest a first media production being produced for an event, to detect a user location of a user with respect to an event location of the event, to register the user as a local event spectator or a remote event spectator based on determining the user location relative to the event location, to receive contributor multimedia content from at least one contributor user registered as one of the local event spectator or the remote event spectator, to synchronize the received contributor multimedia content with the first media production of the event, to transmit a composite multimedia output comprising the synchronized received contributor multimedia content from the at least one contributor user, to receive a user selection of at least one synchronized multimedia content of the composite multimedia output, and to transmit the at least one user selected synchronized multimedia content based on receiving the user selection.

The multimedia collaboration system further includes at least one user device including a user device processor coupled to a user device memory configured to store user device processor instructions that when executed by the user device processor are configured to display an event map on a display of the at least one user device, to receive and display the composite multimedia content, to transmit the user selection to the collaboration server, and to receive and display the at least one user selected synchronized multimedia content in response to transmitting the user selection to the collaboration server.

In another configuration disclosed herein, a multimedia collaboration method includes providing a collaboration server including a collaboration server processor coupled to a collaboration server memory configured to store collaboration server processor instructions that when executed by the collaboration server processor perform the method of ingesting a first media production being produced for an event, of detecting a user location of a user with respect to an event location of the event, of registering the user as an event spectator or a remote event spectator based on determining the user location relative to the event location, of receiving contributor multimedia content from at least one contributor user registered as one of the local event spectator or the remote event spectator, of synchronizing the received contributor multimedia content with the first media production of the event, of transmitting a composite multimedia output comprising the synchronized received contributor multimedia content from the at least one contributor user, of receiving a user selection of at least one synchronized multimedia content of the composite multimedia output, and of transmitting the at least one user selected synchronized multimedia content based on receiving the user selection.

The method further includes providing at least one user device including a user device processor coupled to a user device memory configured to store user device processor instructions that when executed by the user device processor perform the method of displaying an event map on a display of the at least one user device, receiving and display the composite multimedia content, transmitting the user selection to the collaboration server, and receiving and displaying the at least one user selected synchronized multimedia content in response to transmitting the user selection to the collaboration server.

### BRIEF DESCRIPTION OF THE SEVERAL VIEWS OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than may be necessary for a fundamental understanding of the disclosed subject matter and various ways in which it may be practiced.

The embodiments will be better understood from the following detailed description with reference to the drawings, which are not necessarily drawing to scale and in which:

FIG. 1 illustrates a schematic representation of a multimedia collaboration system;

FIG. 2 illustrates a schematic diagram of an exemplary hardware environment of a collaboration server that can be used to implement the embodiments described in FIGS. 1 and 4-18;

FIG. 3 illustrates a schematic diagram of an exemplary hardware environment of a user device that can be used to implement the embodiments described in FIGS. 1 and 4-18;

FIG. 4 illustrates a logic flow chart diagram of the multimedia collaboration system of FIG. 1;

FIG. 5 illustrates a representative user device contributor interface;

FIG. 6 illustrates a representative user device event course map view;

FIG. 7 illustrates a representative user device multimedia view display subsequent a user interaction of FIG. 6;

FIG. 8 illustrates a representative user device multimedia view display subsequent a user interaction of FIG. 7;

FIG. 9 illustrates a representative user device local event spectator map view;

FIG. 10 illustrates the user device local event spectator map view of FIG. 9 receiving a first user interaction;

FIG. 11 illustrates the user device local event spectator map view of FIGS. 9-10 receiving a second user interaction;

FIG. 12 illustrates the user device multimedia view display subsequent the user interaction of FIG. 11;

FIG. 13 illustrates an alternative user device event participation map view similar to FIG. 9, receiving a user input selection of a local event spectator on the map view;

FIG. 14 illustrates the user device multimedia view display subsequent the user interaction of FIG. 13;

FIG. 15 illustrates an alternative user device event participation map view similar to FIG. 9, receiving a plurality of user input selections of local event spectators on the map view;

FIG. 16 illustrates the user device multimedia view display subsequent the user interaction of FIG. 15;

FIG. 17 illustrates the user device event timeline multimedia view including a timeline of the event; and

FIG. 18 illustrates an alternative user device event timeline multimedia view of FIG. 17 including a timeline of the event and a contributor media view replacing the official content view.

### DETAILED DESCRIPTION

Multimedia content modes operating on a system with a collaboration server and at least one user device described herein provide an enhanced user experience over previous user experiences by allowing remote and local event spectators during spectator event to add supplemental user-provided multimedia content that may be synchronized to the official produced content feed and made available for viewing or playback on user devices during the course of the event or subsequent recorded playback after the event.

Supplement user-provided content may be video, digital images, user-provided comments and news articles. All the supplemental content may be organized and synchronized to a timeline of the official production content feed. Users, both remote viewers and those at the spectator event are informed and further entertained with the user-provided supplemental synchronized material in real-time with the event and in viewing the material after the conclusion of the event.

Event spectators can share their experience at the events, at home or wherever they are by using an upload tool on their mobile communication device. Event spectator photos and videos are geotagged, timestamped and automatically synchronized to the timeline of official production media feed.

Videos and animations may be further added by content managers at relevant moments in the event to enhance the viewing experience of users who have access to the supplemental multimedia content. These videos and animations may be from alternative perspective angles, may be animations, technical animations, or feature videos.

Photos added in real time by content managers at relevant moments in the official production content stream are automatically linked to the timeline of the official production content stream. Photos may show close-ups, alternative angles, action that the official production content has missed, technical animations, additional features and historical photos.

News and feature stories may be added by content managers at relevant moments in the official production content stream to provide a deeper analysis to viewers. Supplemental news content may be automatically linked to the timeline of the official production content.

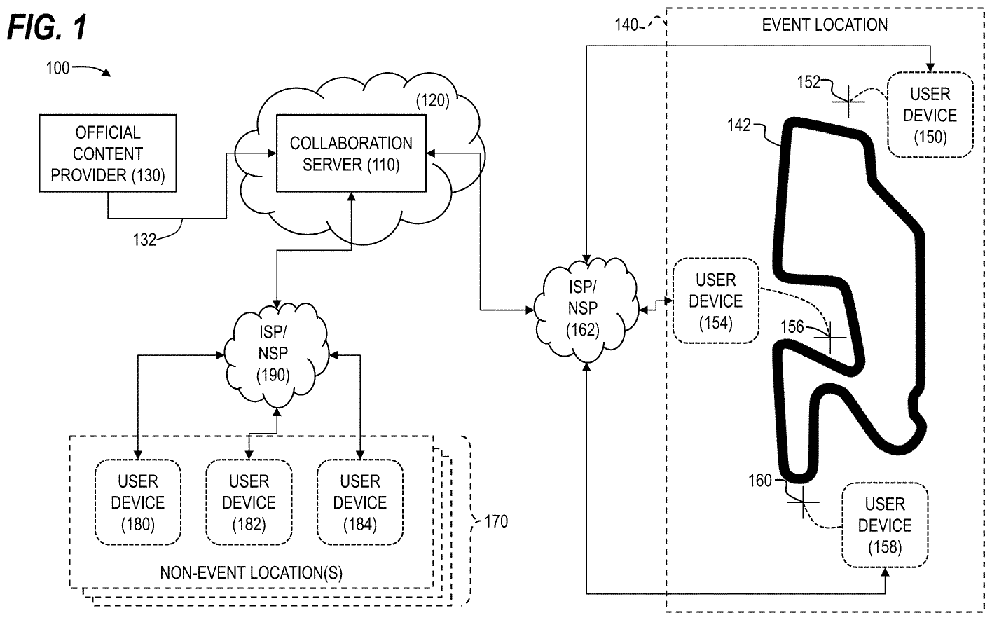

FIG. 1 illustrates a schematic representation of a multimedia collaboration system 100 including a collaboration server 110, (that may be hosted by a cloud-based server hosting system 120), and a plurality of user devices, 150, 154, 158, 180, 182 and 184 executing a software application that allows communication with the collaboration server 110 via respective internet service providers or network communication service providers 162 and 190, respectively.

The collaboration server 110 may receive official production media content 132 from an official content provider 130 of the spectator event. An official content provider 130 may be a network television studio or production company that produces a multi-camera production with event video footage and oftentimes corresponding audio and video commentary for live broadcast or recorded post-event broadcast.

An event location 140 generally defines an area where the spectator event occurs for a period of time scheduled for the event, and where local spectators may watch the event from different locations or venues within the spectator event. FIG. 1 illustrates a representation of the Watkins Glen racetrack 142 as an example venue for a spectator event for the multimedia collaboration system 100 to operate within. For example, a first spectator having a first user device 150, (wherein the user device may include a mobile communication device, such as a smart phone, a tablet computer or a portable laptop computing device), may be geolocated at a first geolocation point 152 determined to be relative to a viewing area at the event location 140. Likewise, a second spectator having a second user device 154 may be geolocated at a second geolocation point 156 determined to be relative to a second viewing area at the event location 140, and a third spectator having a third user device 158 may be geolocated at a third geolocation point 160 determined to be relative to a third viewing area at the event location 140.

Each of the users of the user devices 150, 154 and 158 located within the event location area 140 may have a program executing on their respective user devices that allows each user device to receive the official production media broadcast 132 from the official production media content provider 130 via the collaboration server 110, to capture and/or upload multimedia content via a local internet or network communication service provider 162 to the collaboration server 110, to provide geolocation data of the user device or geolocation data associated with content files on the user device, and to receive and view uploaded multimedia content from other spectator user devices at or remote from the event location 140.

Each of the users of the user devices 180, 182 and 184, are illustrated as being located outside of the event location area 140 and in at least one other non-event location 170 may have a similar program executing on their respective user devices that allows each user device to receive the official production media broadcast 132 from the official production media content provider 130 via the collaboration server 110, to capture and/or upload multimedia content via a local internet or network communication service provider 190 to the collaboration server 110, to provide geolocation data of the user device or geolocation data associated with content files on the user device, and to receive and view uploaded multimedia content from other spectator user-devices at the event location 140 or at a location or locations 170 remote from the event location 140.

When the uploaded multimedia content may be received at the collaboration server 110, the location of the user device may be determined via transmitted geolocation signals of the user device, or by geolocation metadata attached to the uploaded multimedia content from the user devices.

Additionally, the uploaded multimedia content may be stored and synchronized to the timecode of the official production media content so that a composite multimedia content assembled and produced at the collaboration server 110 may be transmitted to any user device executing the program to playback at least the synchronized uploaded multimedia content either with the official production media content and/or with additional uploaded multimedia content.

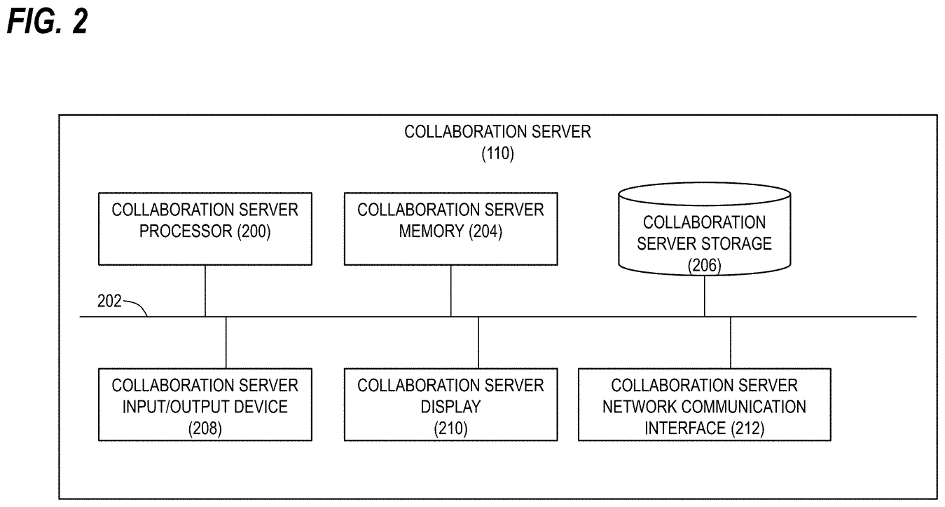

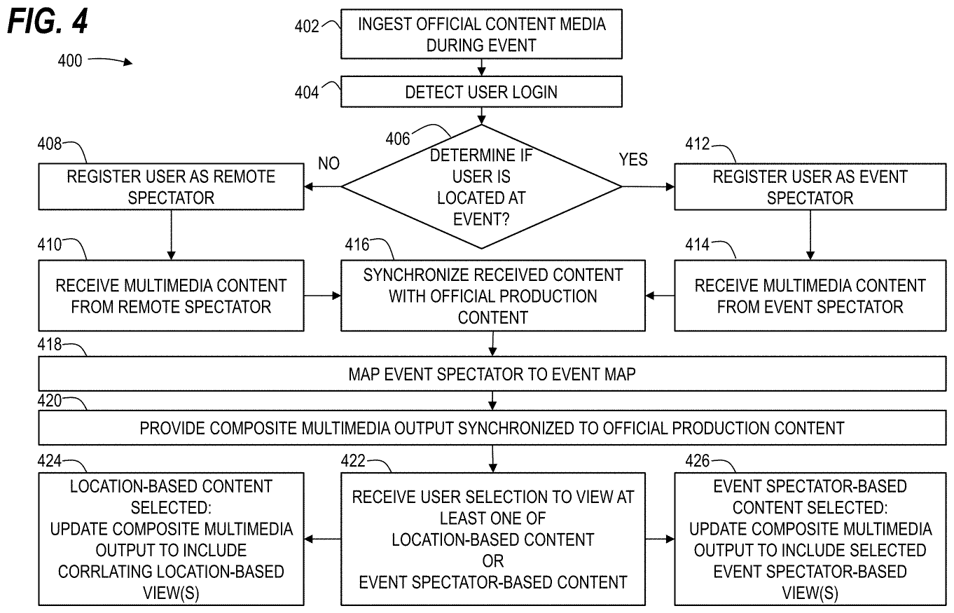

FIG. 2 illustrates a schematic diagram of an exemplary hardware environment of a collaboration server 110 of FIG. 1 that can be used to implement the embodiments described in FIGS. 4-18. Collaboration server 110 includes a collaboration server processor 200 in communication with at least the remainder of the hardware elements of FIG. 2 via a collaboration server bus 202. The collaboration server bus 202 may be further in communication with a collaboration server memory 204 configured to store executable instructions therein for use by the collaboration server processor 200, a collaboration server storage 206 configured to store the executable instructions configured to operate the collaboration server 110 and media content, a collaboration server input/output device 208 configured to receive user and hardware input and transmit signal and data output, a collaboration server display 210 configured to display information from the collaboration server 110 to an operator, and a collaboration server network communication interface 212 configured to receive and transmit data and signals via wired, wireless, optical and electromagnetic spectrum protocols.

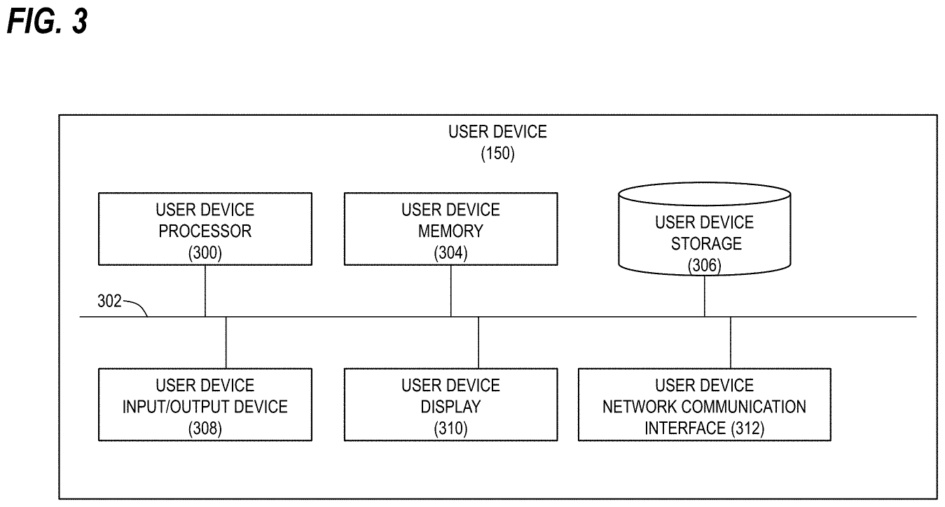

FIG. 3 illustrates a schematic diagram of an exemplary hardware environment of a user device 150 of FIG. 1 that can be used to implement the embodiments described in FIGS. 4-18. User device 150 includes a user device processor 300 in communication with at least the remainder of the hardware elements of FIG. 3 via a user device bus 302. The user device bus 302 may be further in communication with a user device memory 304 configured to store executable instructions therein for use by the user device processor 300, a user device storage 306 configured to store the executable instructions configured to operate the user device 150 and media content, a user device input/output device 308 configured to receive user and hardware input and transmit signal and data output, a user device display 310 configured to display information from the user device 150 to a user, and a user device network communication interface 312 configured to receive and transmit data and signals via wired, wireless, optical and electromagnetic spectrum protocols.

FIG. 4 illustrates a logic flow chart diagram 400 of a method of operation of the collaboration server 110 of FIGS. 1-2 in the multimedia collaboration system 100 of FIG. 1.

The method of operation includes the collaboration server 110 ingesting 402 official production media content 132 produced by an official production media producer 130 during the spectator event. The collaboration server 110 may detect 404 a user spectator login via an application executing on a user device 150 of the user.

The collaboration server 110 then determines 406 if the user that has been detected logging in may be located at a venue of the event. The determination of the user location relative to the event location may be based on a geolocation signal received from the user device, metadata attached to a file uploaded to the collaboration server 110 by the user device, or user input indicating at least one of an address, city, country or specific location.

If the collaboration server 110 determines 406 the user to not be at the event location, that determined user may be registered 408 as a remote spectator, whereinafter the remote spectator user may upload multimedia content tagged with metadata reflecting the user's location registration to be received 410 by the collaboration server 110.

If the collaboration server 110 determines 406 the user to be at the event location, that determined user may be registered 412 as an event spectator, whereinafter the event spectator user may upload multimedia content tagged with metadata reflecting the user's location registration to be received 414 by the collaboration server 110.

In both instances of the registered types of users, as discussed above, the uploaded multimedia content may be saved by the collaboration server 110 to include registered location metadata indicating which type of user registration the media may be associated with. The uploaded multimedia content may also be stored at least with geolocation metadata, time of creation metadata, and user identification or profile metadata. The uploaded multimedia content may then by synchronized 416 in time relative to the timeline of the official production media content 132. Any multimedia content having a timestamp during the time period of the spectator event may be automatically aligned in time for playback with or relative to at timecode of the official production media content. Any multimedia content having a timestamp outside of the time period of the spectator event may be aligned manually relative to a chosen time for playback with or relative to the official production media content timecode.

The collaboration server 110 may also generate a graphical representation of a map of the spectator event to enable the mapping 418 or association of determined geolocation positions of the synchronized uploaded multimedia content with a corresponding location on the displayed map of the spectator event.

The collaboration server 110 may assembly and provide 420 a composite multimedia output including the synchronized uploaded multimedia content of a plurality of contributor spectators, and in one configuration, may provide it consonant with the official production media content 132.

The collaboration server 110 may receive 422 from a user device a user selection to view at least one location-based multimedia content provided by a contributor spectator, or an event spectator-based multimedia content provided by a contributor spectator. Based on the user selection, if the location-based multimedia content may be selected 424, the collaboration server 110 updates or provides with the composite multimedia output a correlating location-based multimedia content to be viewed by the user device 150. Whereas, based on the user selection, if the event spectator-based multimedia content may be selected 426, the collaboration server 110 updates or provides with the composite multimedia output a correlating event spectator-based multimedia content to be viewed by the user device 150.

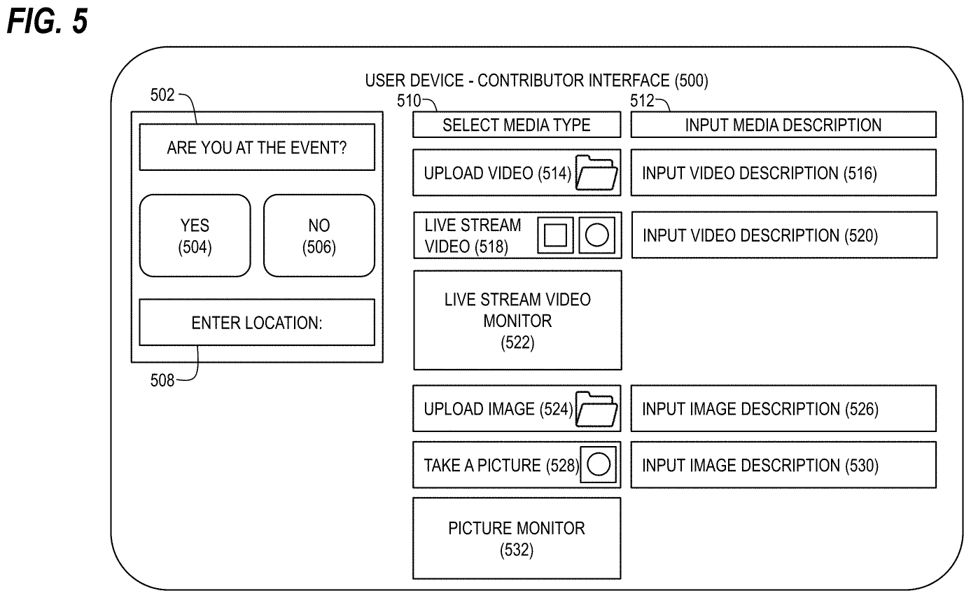

FIG. 5 illustrates a representative user device contributor interface 500 enabled by executable instructions being processed on the user device 150 that enables a user to login to the collaboration multimedia system 100, to provide geolocation information of the user device 150, and to capture and/or upload multimedia content to the multimedia system 100.

After the user completes a login process to the collaboration multimedia system 100, the user may select to display the contributor interface 500 as depicted in FIG. 5. In one configuration of the contributor interface 500, a user geolocation query 502 may be displayed prompting the user to affirm their location relative to the spectator event location by interacting with graphical user interface (GUI) elements that either confirm 504 or deny 506 their location relative to the event location 140, for example as depicted in FIG. 1. If the user inputs that their location may be not at the event location, the contributor interface 500 may further prompt the user to input their actual location 508, where the user may manually enter at least one of an address, a city, a state, province, a country or any other location description. In one configuration of the collaboration system 100, the user input geolocation may be saved by the collaboration system 100 either at the collaboration server 110 or locally on the user device 150 for use in attributing any recorded and/or uploaded multimedia content that may be transferred from the user device 150 to the collaboration server 110.

The contributor interface 500 further includes a user prompt or description to select a media type 510 to record and/or upload to the collaboration server 110 and a user prompt or description to input a media description 512 for the same recorded and/or uploaded media. For example, a GUI element may be provided to enable the user to upload a video file 514 from a local storage device, (for example, user storage device 306 of FIG. 3), and another GUI element to receive a user input video description 516 to be associated with the video file. Thereafter, the video file and associated user provided description may be transmitted from the user device 150 to the collaboration server 110 as depicted in FIG. 1.

In another example, a GUI element may be provided to enable the user to begin a live stream video file 518 using a digital video image sensor on the user device 150, (for example, generally defined as a user device input device 308 of FIG. 3), and another GUI element to receive a user input video description 520 to be associated with the live stream video file. Thereafter, the live stream video file and associated user provided description may be transmitted in real-time from the user device 150 to the collaboration server 110 as depicted in FIG. 1. The user device contributor interface 500 may further include a live stream video monitor 522 display, (for example, generally defined as a user device display 310 of FIG. 3), to enable the user to monitor the live stream video being captured on the user device 150.

In another example, a GUI element may be provided to enable the user to upload a graphic image file 524 from a local storage device, (for example, user storage device 306 of FIG. 3), and another GUI element to receive a user input image file description 526 to be associated with the image file. Thereafter, the graphic image file and associated user provided description may be transmitted from the user device 150 to the collaboration server 110 as depicted in FIG. 1.

In another example, a GUI element may be provided to enable the user to initiate capture of a graphic image file 528 using a digital image sensor on the user device 150, (for example, generally defined as a user device input device 308 of FIG. 3), and another GUI element to input an image description 530 to be associated with the graphic image file. Thereafter, the graphic image file and associated user provided description may be transmitted in from the user device 150 to the collaboration server 110 as depicted in FIG. 1. The user device contributor interface 500 may further include a graphic image picture monitor 532 display, (for example, generally defined as a user device display 310 of FIG. 3), to enable the user to frame and review the graphic image being captured on the user device 150.

In an alternative configuration of the collaboration system 100, geolocation information associated with file metadata generated at the time of a multimedia content, (for example, the video content, graphical image content and description content) may be determined by the collaboration system 100 either at the collaboration server 110 or locally on the user device 150 that may be transferred with the contributor multimedia content from the user device 150 to the collaboration server 110. The user device may capture geolocation information from an onboard Global Position System (GPS) receiver device, (for example, generally defined as a type of user device input device 308 of FIG. 3), where the received geolocation information may be processed by a geolocation determining system, (for example, generally defined as being enabled by executable instructions being executed on the user device processor 300 of FIG. 3), to determine a specific geolocation of the user device.

The geolocation may then be appended as metadata to any multimedia file created on the user device 150. The collaboration server 110, upon receipt of the appended geolocation metadata with the multimedia content, may determine the geolocation of the multimedia content. The geolocation information may further include coordinates in a geospatial reference frame and timecode information supplied by GPS signals received by the user device 150 at the time of the multimedia content file creation. The timecode information may also include a continuous timecode associated with live stream video content generated by the user device 150.

Additional user device generated metadata associated with received contributor multimedia content synchronized by the collaboration server 110 may further include camera field of view data, (for example, lens focal length data of the camera on the user device 150 used to record video or graphic image data), and user device orientation data that may include a compass or directional heading associated with a video or graphic image taken on the user device. The user device orientation data may be based on a user device magnetometer sensor and/or a user device gyroscope sensor that may each collect sensor data and associate the collected orientation data to the multimedia content when it is created. The field of view data and orientation data may be collected and transmitted by the collaboration server to a user device so that a user input on the user device may select a contributor multimedia content based on the field of view data and/or the orientation data in addition to the geolocation data disclosed herein.

From any of the above described geolocation information supplied by the user device 150 relative to multimedia content provided to the collaboration server 110, the collaboration server 110 may determine, (see 406 in FIG. 4), whether the user location associated with received multimedia content may be coincident the spectator event location, (see, for example, 140 in FIG. 1). In one configuration, the collaboration server 110 may determine if the received geolocation information may be within a predetermined distance from a central geolocation point of the event location 140. In another configuration, the collaboration server 110 may determine if the received geolocation information may be within a predetermined geolocation boundary, (for example, a geofence boundary), around a perimeter of the event location 140.

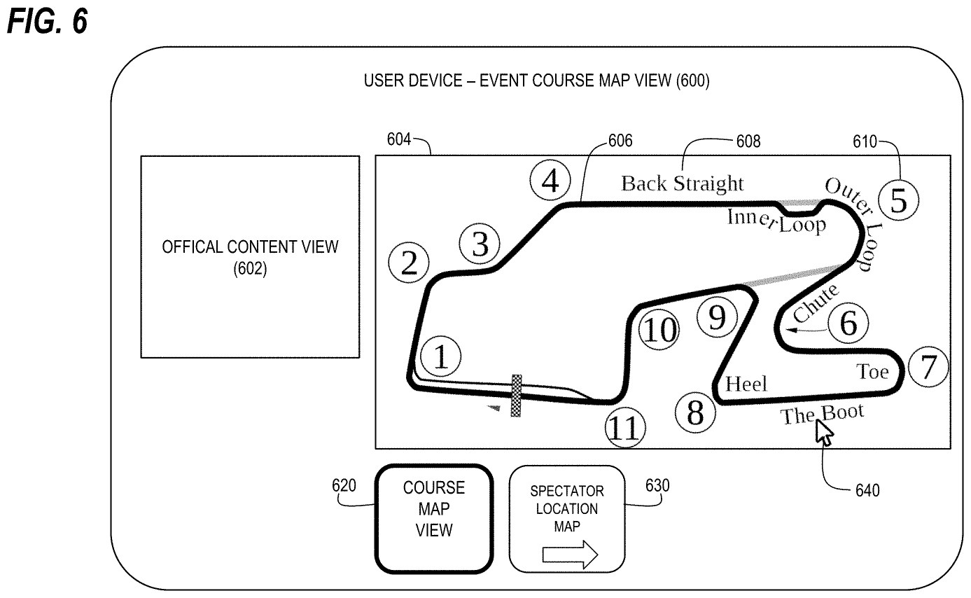

FIG. 6 illustrates a representative user device event course map view 600 including an official content view 602 that may include the real-time official production content provided by the official content provider 130, (see FIG. 1), and an event course map 604 that may be generated by the collaboration server 110 and transmitted to the user device 150.

In one configuration, the event course map 604 may include a general representation of a course layout 606, (similar to the course representation 142 of FIG. 1), further including user-selectable GUI elements at corresponding to location features of the real-world course or spectator event venue, (for example in the alternative, a concert performance at a performance venue, a sailing race on body of water, or an endurance race covering larger distances than a circuit-based race course 142 of FIG. 1). In this exemplary configuration, the course layout 606 of the event course map may include user selectable textual descriptors 608, (for example, “Back Straight”), and graphical icons 610 representing areas withing the event course map 604 that may be selected by the user on a user interface of the user device 150.

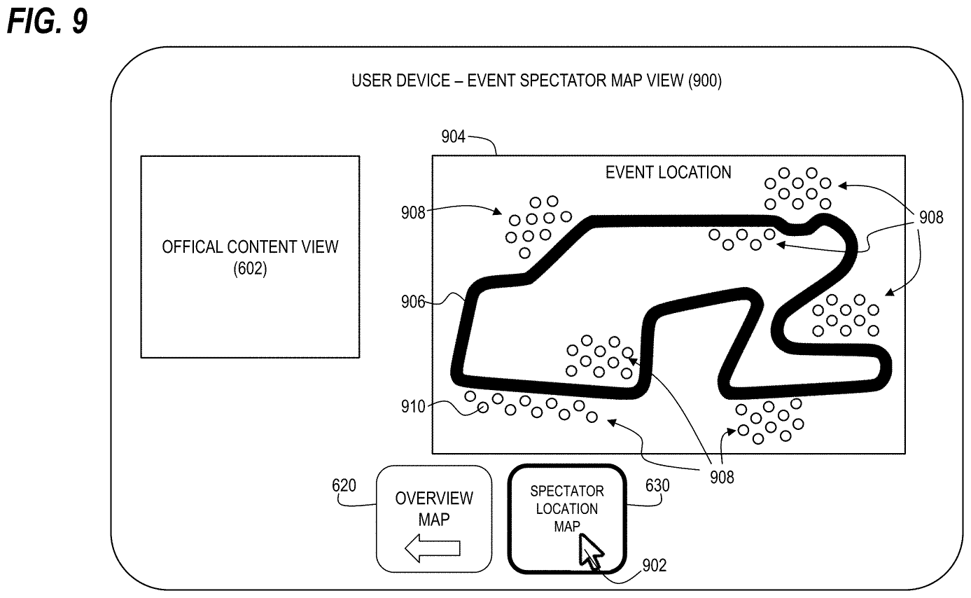

One configuration of the event course map view 600 includes GUI elements configured to enable the user to select between a course map view 620, (represented as being currently selected by the bolded outline), and a spectator location map, (later described in FIGS. 9-11, 13, and 15).

For example, a user selection element 640 on the textual descriptor, “The Boot,” may represent a mouse movement of a user input device or a touch input received on touchscreen display of the user input device. An alternative example of a user selection of a graphical element within an event course map view, not shown, may be a concert performance where the course map 606 of FIG. 6 may be replaced by a concert performance venue map enabling a user to select an area, areas or contributor participants within the concert venue.

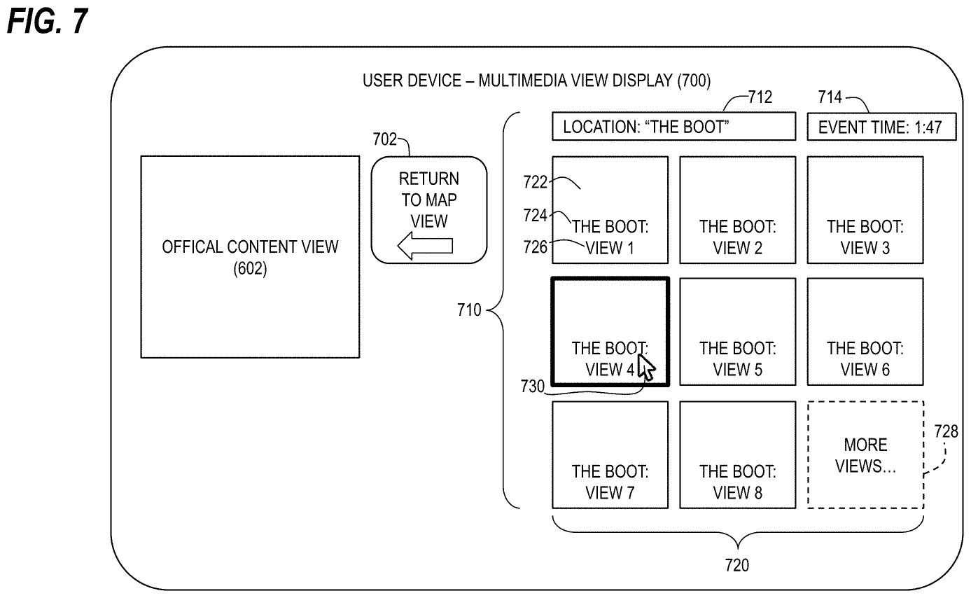

FIG. 6 illustrates a user selection element 640 selecting the textual descriptor, “The Boot,” that may cause the user device 150 to switch to a multimedia view display 700 represented by FIG. 7. FIG. 7 illustrates a representative user device multimedia view display 700 subsequent the user interaction, (for example, via user selection element 640) of FIG. 6.

The user device multimedia view display 700 includes a GUI element enabling the user to return 702 to the previous event course map view 600 of FIG. 6. The user device multimedia view display 700 further includes, for example, the official content view 602, and a contributor multimedia content viewing section 710 including a location description 712 corresponding to the user selection as illustrated in FIG. 6, an event time display 714 corresponding to the official content view 602, and a plurality of contributor multimedia content 720, where each content includes a display area 722, and may include a location description 724 and a contributor or unique identification description 726. Another GUI element may enable the user to select additional views 728 that are available for display on the user device 150.

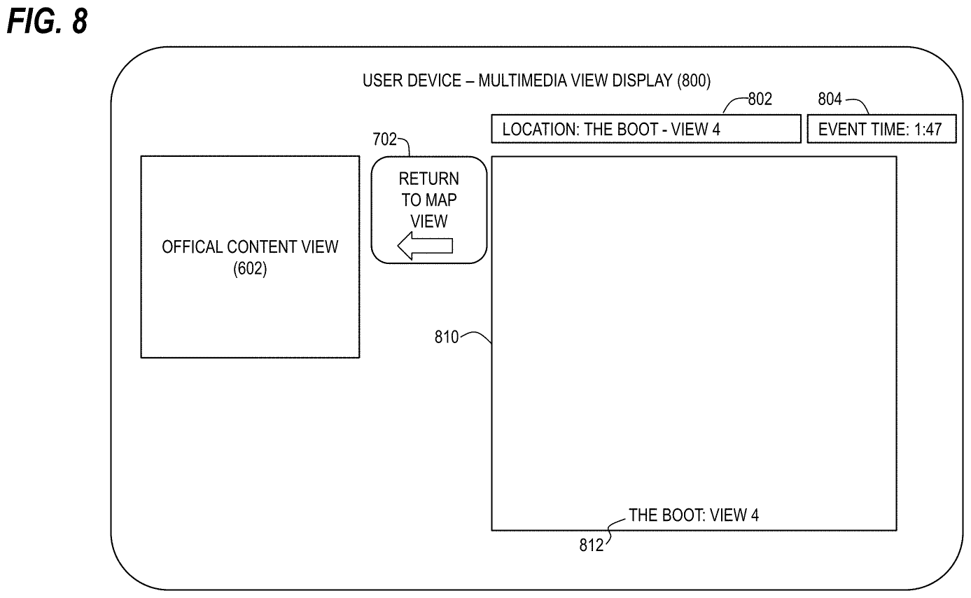

FIG. 7 further illustrates a user selection element 730 selecting one contributor multimedia content, (“THE BOOT: VIEW 4”), whereupon selection, the multimedia view display 700 may change to the view of FIG. 8 illustrating a representative user device multimedia view display 800 subsequent a user interaction of FIG. 7 that replaces the plurality of contributor multimedia content 720 of FIG. 7 with a single multimedia content 810 include a description 812 and updating the location description 802 and providing an event time 804 display.

FIG. 9 illustrates a representative user device event spectator map view 900 in a configuration where a user may select 902 the GUI element corresponding to the spectator location map 630 to enable a display of an event spectator map 904 that includes a representation of a course 906, (or spectator venue, as described above), and groups of spectators 908 that consist of individual geolocated spectators 910, (based on the geolocation determination of the collaboration server 110, described above).

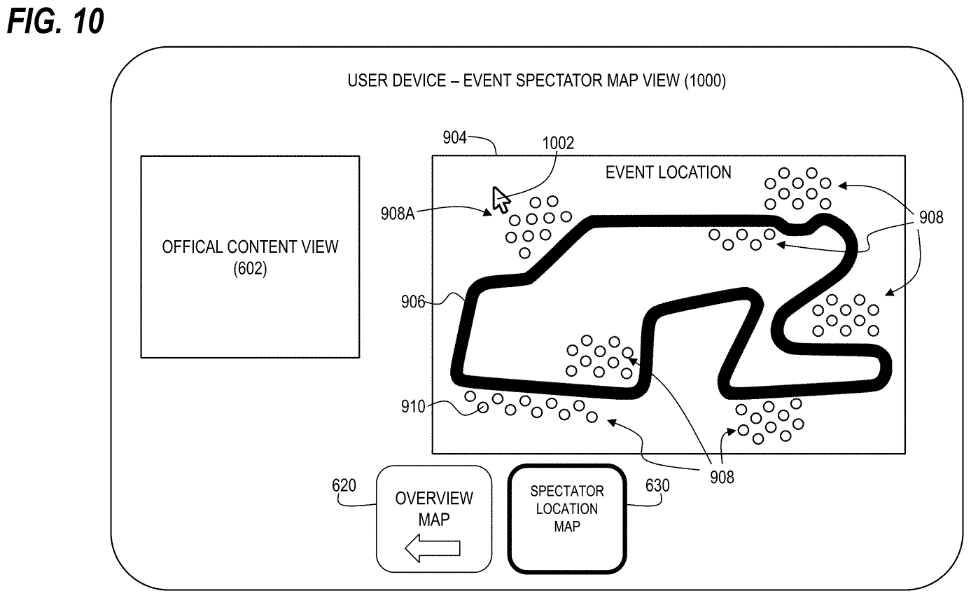

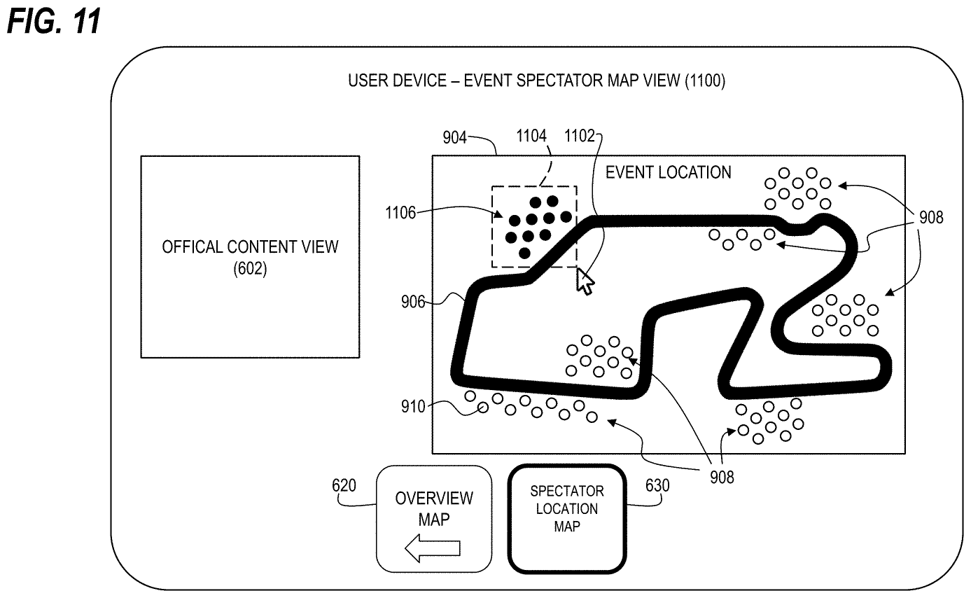

FIG. 10 illustrates the user device event spectator map view 1000 of FIG. 9 receiving a first user interaction 1002 that begins to select an area proximate the course 906 including a group of geolocated spectators 908A. FIG. 11 illustrates the user device event spectator map view 1100 of FIGS. 9-10 receiving a second user interaction 1102, that may include a conclusion of the first user interaction 1002 of FIG. 10, configured to select geolocated spectators 1106 by a boundary box 1104. The boundary box 1104 may be input by a user input device including a mouse input device or a touchscreen interface device allowing the user to select geolocated spectators within a user designated area of the event spectator map view 1100.

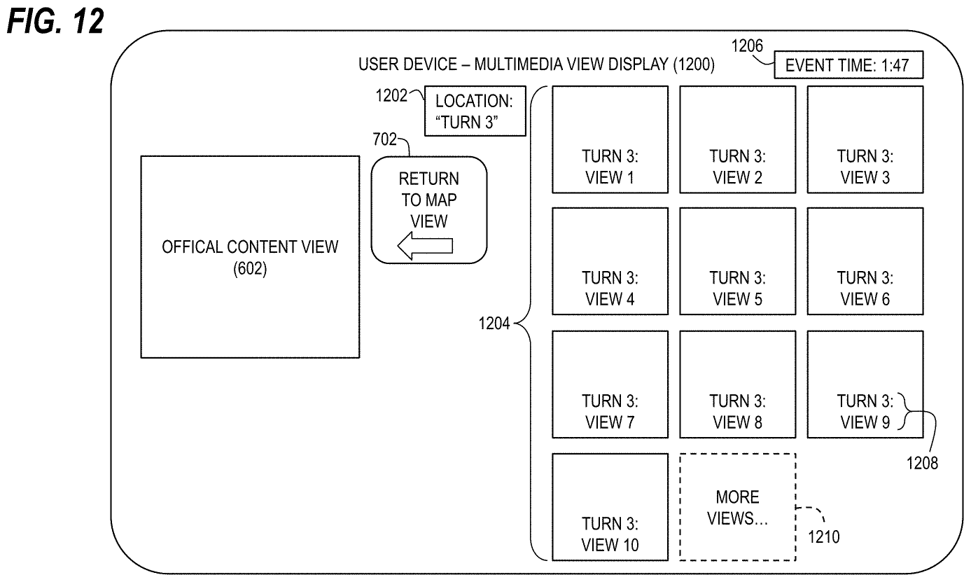

FIG. 12 illustrates the user device multimedia view display 1200 subsequent the user interaction of selecting the geolocated spectators 1106 of FIG. 11. The user device multimedia view display 1200 includes a location description 1202 corresponding to an area within the event location where the geolocated spectator was selected, a contributor multimedia content display area 1204 and an event time 1206 display corresponding to the official production media displayed in the official content view 602.

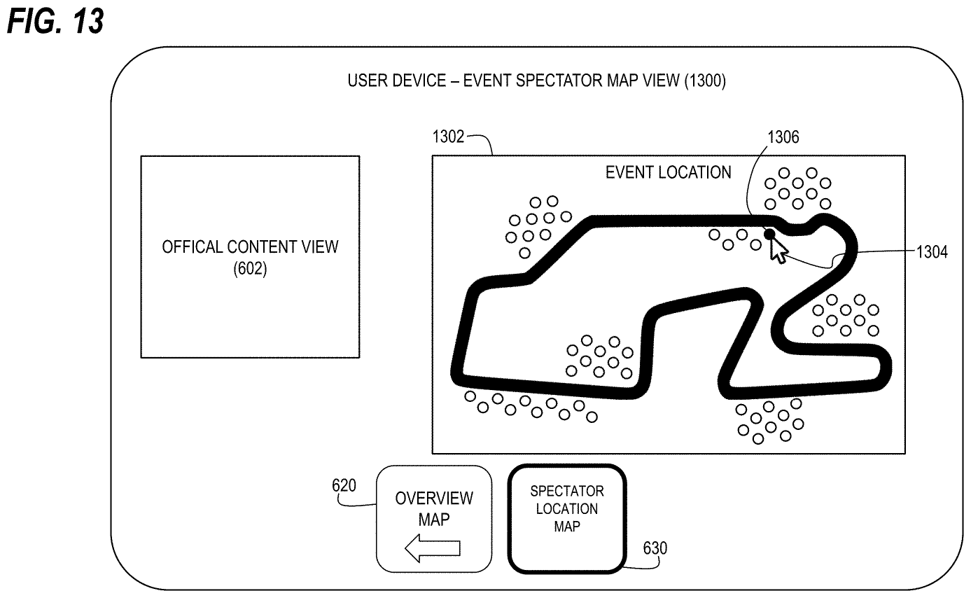

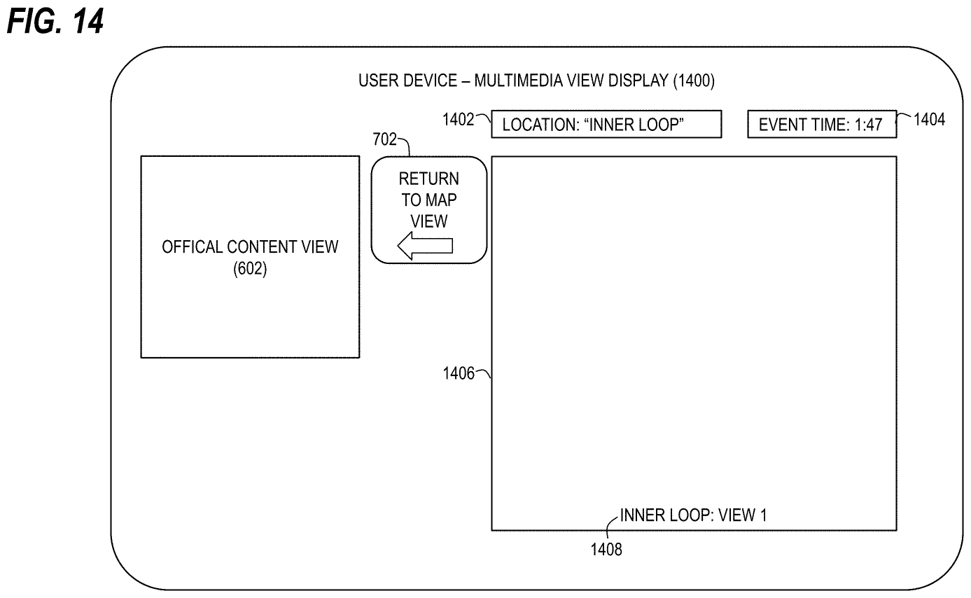

FIG. 13 illustrates an alternative user device event participation map view 1300 similar to FIG. 9 but receiving a user input selection 1304 of a single event spectator 1306 on the map view 1302. FIG. 14 illustrates the user device multimedia view display 1400 subsequent the user interaction 1304 of the of FIG. 13 where the contributor multimedia content 1406 may be displayed with location information 1402, event time information 1404 and description information 1408.

In another configuration, when a spectator contributor uploads or streams multimedia content to the collaboration server 110 without any description content input, the collaboration server 110 may generate and input description content including, a unique contributor identification, a determined geolocation of the contributor spectator or any other description to differentiate the contributor multimedia content from other contributor provided multimedia content.

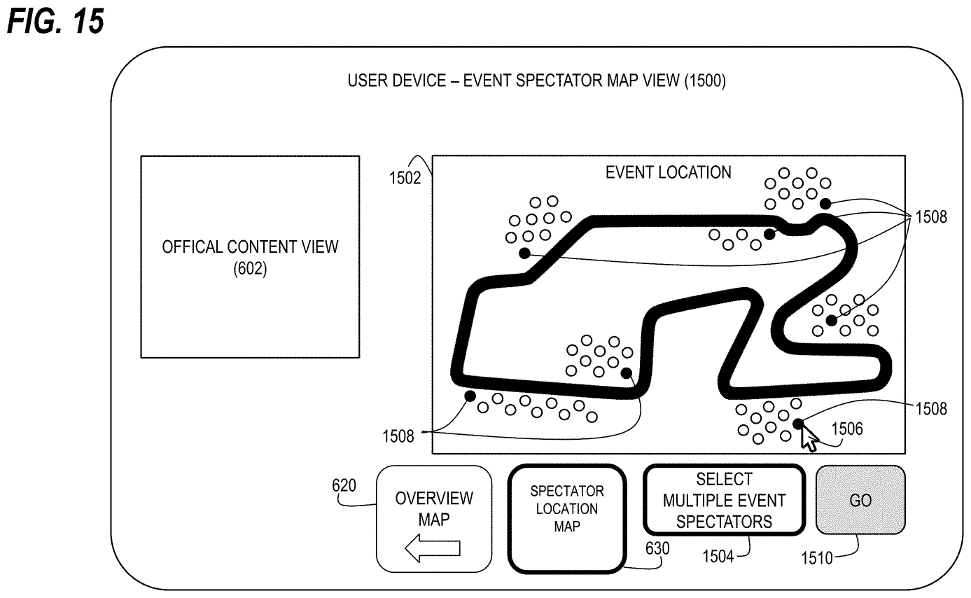

FIG. 15 illustrates an alternative user device event participation map view 1500 similar to FIG. 9, that enables receiving a plurality of user input selections 1506 of event spectators on the map view. In this event spectator map view, the user may select a GUI element enabling the selection of multiple event spectators 1504 multimedia content to be displayed on the user device 150. The user device then enables the selection 1506 of multiple event spectators 1508 and submit 1510 the final selection of multiple event spectators to the collaboration server 110.

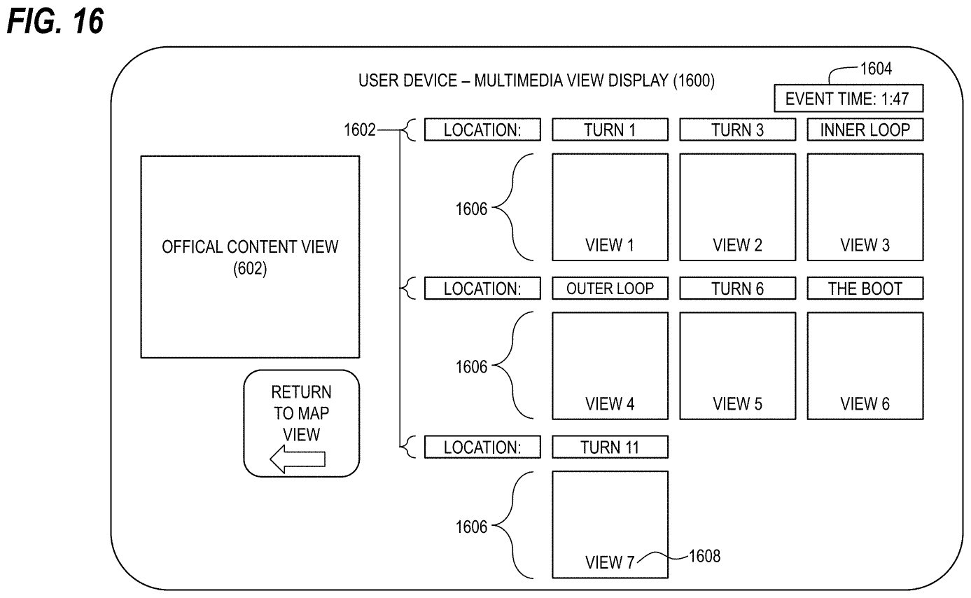

FIG. 16 illustrates the user device multimedia view display 1600 subsequent the user interaction of FIG. 15 that selects multiple event spectators 1508. Location descriptions 1602 are provided for each of the plurality of contributor multimedia content 1606 that have been selected by the user in addition to an event time 1604 corresponding to the official production content displayed in the official content view 602. Descriptors 1608 may be displayed with the contributor multimedia content providing spectator identification, spectator location or any other collaboration server 110 provided information.

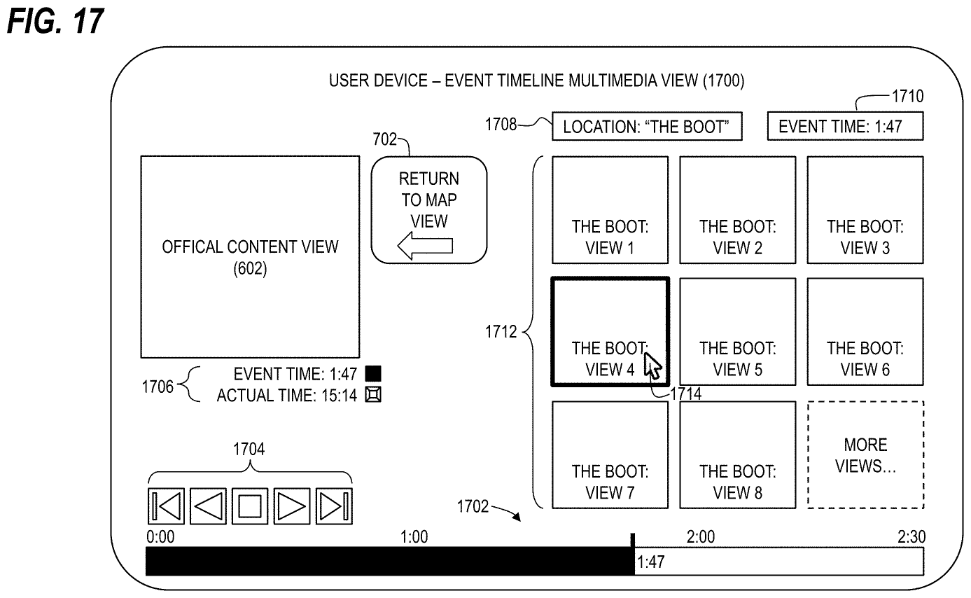

FIG. 17 illustrates a user device event timeline multimedia view 1700 including a timeline 1702 of the event that enables a user to “scrub” to a particular point in time the event, whether the event may be in progress and may be being live-streamed to the official content view 602, or the event has concluded and the user may be watching a recorded playback of the event including the official production media content and the synchronized contributor multimedia content on the user device 150.

The event timeline 1702 further includes user selectable media playback controls 1704 and a user selectable time type GUI elements 1706 that enable the user device 150 to display a time of the contributor multimedia content relative to the elapsed event time or based on a Uniform Coordinated Time (UTC) referenced time.

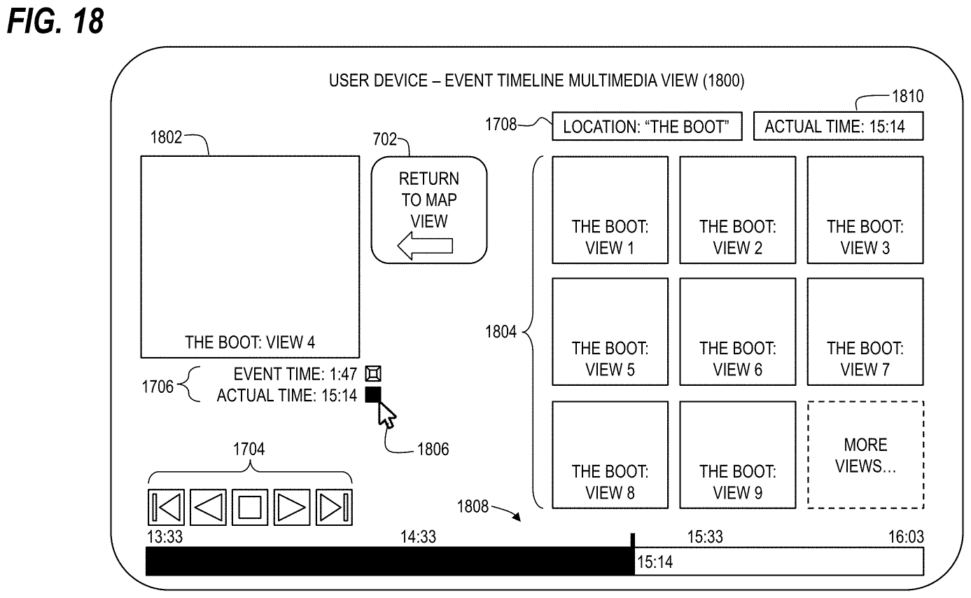

The user device event timeline multimedia view 1700 further includes a location description 1708 element, an event time 1710 element displaying a time corresponding to the selection of the time type GUI elements 1706, and a contributor multimedia content view section 1712. FIG. 17 further illustrates a representative user input selection 1714 of one contributor multimedia content that changes the timeline multimedia view 1700 of FIG. 17 to an alternative user device event timeline multimedia view 1800 of FIG. 18.

FIG. 18 illustrates the alternative user device event timeline multimedia view 1800 subsequent to the user input selection 1714 of FIG. 17 including an alternative timeline 1808 of the event and a contributor media view 1802 replacing the official content view 602 as illustrated in FIG. 17 such that all media displayed on the user device 150 in the event timeline multimedia view 1800 may be contributor multimedia content. Since the displayed contributor multimedia content may be synchronized for playback to the official production media content, all the displayed contributor multimedia content in FIG. 18 may be effectively synchronized to each other for the event during playback on the user device 150.

FIG. 18 further illustrates the time type GUI elements 1706 being selected 1806 to display an actual (UTC-referenced) time that changes the time displays of the timeline 1808 and the actual time display element 1810. The contributor multimedia content view section 1712 of FIG. 17 may be updated to a contributor multimedia content view section 1804 that replaces the selected contributor multimedia content of FIG. 17 with another contributor multimedia content.

One configuration of a multimedia collaboration system described herein includes a collaboration server having a collaboration server processor coupled to a collaboration server memory configured to store collaboration server processor instructions. When the collaboration server processor instructions are executed by the collaboration server processor, the collaboration server may be configured to ingest a first media production being produced for an event, to detect a user location of a user with respect to an event location of the event, to register the user as a local event spectator or a remote event spectator based on determining the user location relative to the event location, to receive contributor multimedia content from at least one contributor user registered as one of the local event spectator or the remote event spectator, to synchronize the received contributor multimedia content with the first media production of the event, to transmit a composite multimedia output comprising the synchronized received contributor multimedia content from the at least one contributor user, to receive a user selection of at least one synchronized multimedia content of the composite multimedia output, and to transmit the at least one user selected synchronized multimedia content based on receiving the user selection.

The above configuration of the multimedia collaboration system described herein may further include at least one user device including a user device processor coupled to a user device memory configured to store user device processor instructions. When the user device processor instructions are executed by the user device processor, the at least one user device may be configured to display an event map on a display of the at least one user device, to receive and display the composite multimedia content, to transmit the user selection to the collaboration server, and to receive and display the at least one user selected synchronized multimedia content in response to transmitting the user selection to the collaboration server.

Another configuration of the multimedia collaboration includes the first media production being an official media production produced in real-time from the event.

Another configuration of the multimedia collaboration includes determining the user location with respect to the event location being based on at least one of a user input designation of user location, received GPS signal data from the user device, and embedded geolocation metadata in the contributor multimedia content from the at least one user device.

Another configuration of the multimedia collaboration includes the received contributor multimedia content including at least one of user provided video content, user provided graphical image content, or user provided description content.

Another configuration of the multimedia collaboration includes synchronizing the received contributor multimedia content with the first media production of the event being based on synchronizing to a timecode of the first media production.

Another configuration of the multimedia collaboration includes the composite multimedia output including the first media production with a plurality of the synchronized contributor multimedia content.

Another configuration of the multimedia collaboration includes providing the composite multimedia output to further include outputting a real-time live stream of the first media production.

Another configuration of the multimedia collaboration includes receiving the user selection occurs during a time during a performance of the event.

Another configuration of the multimedia collaboration includes providing the composite multimedia output after a conclusion of the event.

Another configuration of the multimedia collaboration includes receiving the user selection occurring after the conclusion of the event.

Another configuration of the multimedia collaboration includes transmitting the at least one user selected synchronized multimedia content based on receiving the user selection further transmits the first media production.

Another configuration of the multimedia collaboration includes transmitting the at least one user selected synchronized multimedia content based on receiving the user selection further transmits a second contributor user provided synchronized multimedia content.

Another configuration of the multimedia collaboration includes the at least one user selected at least one synchronized multimedia content of the composite multimedia output including at least one of a location-based multimedia content, an event spectator-based multimedia content, and a remote event spectator-based multimedia content.

Another configuration of the multimedia collaboration includes the user selection of the location-based multimedia content being based on a user selected location within the event.

Another configuration of the multimedia collaboration includes the user selection of the event spectator-based multimedia content being based on a user selected event spectator.

Another configuration of the multimedia collaboration includes the user device processor being further configured to receive a selection to display a time with the synchronized contributor multimedia content, where the time may be one of a time within an elapsed time of the event, or a time of day.

Another configuration of the multimedia collaboration includes the collaboration server processor being further configured to generate the event map of the event that includes at least one of the user location of the user registered as the local event spectator, or at least one region within the event location corresponding to at least one registered local event spectator.

Another configuration of the multimedia collaboration includes the event map further includes one of a display of a plurality of user selectable regions within the event map, each of the plurality of user selectable regions corresponding to at least one contributor user registered as a local event spectator, and a display of a plurality of location determined contributor users registered as local event spectators within the event map.

Another configuration of the multimedia collaboration includes the user selection corresponding to one of the plurality of user selectable regions within the event map, and at least one location determined contributor user within the event map.

In another configuration, a multimedia collaboration method includes providing a collaboration server including a collaboration server processor coupled to a collaboration server memory configured to store collaboration server processor instructions. When the collaboration server processor instructions are executed by the collaboration server processor, the processor server may perform the method of ingesting a first media production being produced for an event, of detecting a user location of a user with respect to an event location of the event, of registering the user as an event spectator or a remote event spectator based on determining the user location relative to the event location, of receiving contributor multimedia content from at least one contributor user registered as one of the local event spectator or the remote event spectator, of synchronizing the received contributor multimedia content with the first media production of the event, of transmitting a composite multimedia output comprising the synchronized received contributor multimedia content from the at least one contributor user, of receiving a user selection of at least one synchronized multimedia content of the composite multimedia output, and of transmitting the at least one user selected synchronized multimedia content based on receiving the user selection.

The above configuration of the multimedia collaboration method described herein may further include providing at least one user device including a user device processor coupled to a user device memory configured to store user device processor instructions. When the at least one user device processor instructions are executed by the at least one user device processor, the at least one user device may perform the method of displaying an event map on a display of the at least one user device, of receiving and display the composite multimedia content, of transmitting the user selection to the collaboration server, and of receiving and displaying the at least one user selected synchronized multimedia content in response to transmitting the user selection to the collaboration server.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code may be loaded into and executed by a computer, for example, collaboration server processor 200 and/or user device processor 300, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code may be loaded into and executed by a computer, the computer becomes an apparatus for practicing implementations of the disclosed subject matter. When implemented on a general-purpose microprocessor, the computer program code segments configure the microprocessor to generate specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

What is claimed is:

1. A multimedia collaboration system comprising:
a collaboration server including a collaboration server processor coupled to a collaboration server memory configured to store collaboration server processor instructions that when executed by the collaboration server processor are configured to
ingest a first media production being produced for an event,
detect a user location of a user with respect to an event location of the event,
register the user as a local event spectator or a remote event spectator based on determining the user location relative to the event location,
receive contributor multimedia content from at least one contributor user registered as one of the local event spectator or the remote event spectator,
synchronize the received contributor multimedia content with the first media production of the event,
transmit a composite multimedia output comprising the synchronized received contributor multimedia content from the at least one contributor user,
receive a user selection of at least one synchronized multimedia content of the composite multimedia output, and
transmit the at least one user selected synchronized multimedia content based on receiving the user selection; and
at least one user device including a user device processor coupled to a user device memory configured to store user device processor instructions that when executed by the user device processor are configured to
display an event map on a display of the at least one user device,
receive and display the composite multimedia content,
transmit the user selection to the collaboration server, and
receive and display the at least one user selected synchronized multimedia content in response to transmitting the user selection to the collaboration server.

2. The multimedia collaboration system of claim 1, wherein the first media production is an official media production produced in real-time from the event.

3. The multimedia collaboration system of claim 1, wherein determining the user location with respect to the event location is based on at least one of
a user input designation of user location,
received GPS signal data from the user device, and
embedded geolocation metadata in the contributor multimedia content from the at least one user device.

4. The multimedia collaboration system of claim 1, wherein the received contributor multimedia content comprises at least one of user provided video content, user provided graphical image content, or user provided description content.

5. The multimedia collaboration system of claim 1, wherein synchronizing the received contributor multimedia content with the first media production of the event is based on synchronizing to a timecode of the first media production.

6. The multimedia collaboration system of claim 1, wherein the composite multimedia output comprises the first media production with a plurality of the synchronized contributor multimedia content.

7. The multimedia collaboration system of claim 1, wherein providing the composite multimedia output further comprises outputting a real-time live stream of the first media production.

8. The multimedia collaboration system of claim 7, wherein receiving the user selection occurs during a time during a performance of the event.

9. The multimedia collaboration system of claim 1, wherein providing the composite multimedia output is performed after a conclusion of the event.

10. The multimedia collaboration system of claim 9, wherein receiving the user selection occurs after the conclusion of the event.

11. The multimedia collaboration system of claim 1, wherein transmitting the at least one user selected synchronized multimedia content based on receiving the user selection further transmits the first media production.

12. The multimedia collaboration system of claim 1, wherein transmitting the at least one user selected synchronized multimedia content based on receiving the user selection further transmits a second contributor user provided synchronized multimedia content.

13. The multimedia collaboration system of claim 1, wherein the at least one user selected at least one synchronized multimedia content of the composite multimedia output comprises at least one of
a location-based multimedia content,
an event spectator-based multimedia content, and
a remote event spectator-based multimedia content.

14. The multimedia collaboration system of claim 13, wherein the user selection of the location-based multimedia content is based on a user selected location within the event.

15. The multimedia collaboration system of claim 13, wherein the user selection of the event spectator-based multimedia content is based on a user selected event spectator.

16. The multimedia collaboration system of claim 1, wherein the user device processor is further configured to receive a selection to display a time with the synchronized contributor multimedia content, wherein the time is one of a time within an elapsed time of the event, or a time of day.

17. The multimedia collaboration system of claim 1, wherein the collaboration server processor is further configured to generate the event map of the event that includes at least one of
the user location of the user registered as the local event spectator, or
at least one region within the event location corresponding to at least one registered local event spectator.

18. The multimedia collaboration system of claim 17, wherein the event map further comprises one of
a display of a plurality of user selectable regions within the event map, each of the plurality of user selectable regions corresponding to at least one contributor user registered as a local event spectator, and
a display of a plurality of location determined contributor users registered as local event spectators within the event map.

19. The multimedia collaboration system of claim 18, wherein the user selection corresponds to one of
the plurality of user selectable regions within the event map, and
at least one location determined contributor user within the event map.

20. A multimedia collaboration method comprising:
providing a collaboration server including a collaboration server processor coupled to a collaboration server memory configured to store collaboration server processor instructions that when executed by the collaboration server processor perform the method of
ingesting a first media production being produced for an event,
detecting a user location of a user with respect to an event location of the event,
registering the user as an event spectator or a remote event spectator based on determining the user location relative to the event location,
receiving contributor multimedia content from at least one contributor user registered as one of the local event spectator or the remote event spectator,
synchronizing the received contributor multimedia content with the first media production of the event,
transmitting a composite multimedia output comprising the synchronized received contributor multimedia content from the at least one contributor user,
receiving a user selection of at least one synchronized multimedia content of the composite multimedia output, and
transmitting the at least one user selected synchronized multimedia content based on receiving the user selection; and
providing at least one user device including a user device processor coupled to a user device memory configured to store user device processor instructions that when executed by the user device processor perform the method of
displaying an event map on a display of the at least one user device,
receiving and display the composite multimedia content,
transmitting the user selection to the collaboration server, and
receiving and displaying the at least one user selected synchronized multimedia content in response to transmitting the user selection to the collaboration server.
